(19) United States
(12) Patent Application Publication
(10) Pub. No.: US 2025/0061838 A1
(43) Pub. Date: Feb. 20, 2025

(54) ELECTRONIC DEVICE AND METHOD FOR CONTROLLING FRAME RATE OF APPLICATION

(71) Applicant: MEDIATEK INC., Hsinchu City (TW)

(72) Inventors: Yi-Hsin SHEN, Hsinchu City (TW); Cheng-Che CHEN, Hsinchu City (TW); Yen-Po CHIEN, Hsinchu City (TW); Chung-Hao HO, Hsinchu City (TW); Jen-Chih CHANG, Hsinchu City (TW); Chiu-Jen LIN, Hsinchu City (TW)

(21) Appl. No.: 18/805,824

(22) Filed: Aug. 15, 2024

Related U.S. Application Data
(60) Provisional application No. 63/520,376, filed on Aug. 18, 2023.

(51) Int. Cl. G09G 3/20; G09G 5/12

(52) U.S. Cl. CPC G09G 3/2096; G09G 5/12; G09G 2330/023; G09G 2340/0435

(57) ABSTRACT

An electronic device is provided. The electronic device includes a display panel and a controller coupled to the display panel. The display panel is configured to update displayed images at a refresh rate. The controller is configured to receive a target frame rate from a first application. The controller is further configured to determine a frame rate according to the refresh rate and the target frame rate. The frame rate is a factor of the refresh rate. The controller is further configured to control the first application to draw images at the frame rate.

### CROSS REFERENCE TO RELATED APPLICATIONS

This application claims priority of U.S. Provisional Application Ser. No. 63/520,376, filed on 2023 Aug. 18, the entirety of which is incorporated by reference herein.

### BACKGROUND OF THE INVENTION

### Field of the Invention

The present invention relates to method for controlling the frame rate of an application, and, in particular, it relates to a method for controlling the frame rate of an application according to the refresh rate of the display panel.

### Description of the Related Art

Many applications are able to provide different frame rates. However, an incorrect frame rate will cause the frame display time to be inconsistent and the display latency to be long, and this may negatively impact user experience. Thus, determining the appropriate frame rate and controlling the draw timing of the application is pivotal to the improvement of user experience. A method for determining the appropriate frame rate of an application is required. Furthermore, a method for controlling the application to draw images at the determined frame rate is required.

### BRIEF SUMMARY OF THE INVENTION

An embodiment of the present invention provides an electronic device. The electronic device comprises a display panel and a controller coupled to the display panel. The display panel is configured to update displayed images at a refresh rate. The controller is configured to receive a target frame rate from a first application. The controller is further configured to determine a frame rate according to the refresh rate and the target frame rate. The frame rate is a factor of the refresh rate. The controller is further configured to control the first application to draw images at the frame rate.

An embodiment of the present invention provides a method for controlling the frame rate of an application. The method is applicable to an electronic device. The electronic device comprises a display panel and a controller coupled to the display panel. The display panel is configured to update displayed images at a refresh rate. The method comprises receiving a target frame rate from a first application via the controller. The method further comprises determining a frame rate according to the refresh rate and the target frame rate, wherein the frame rate is a factor of the refresh rate via the controller. The method further comprises controlling the first application to draw images at the frame rate via the controller.

### BRIEF DESCRIPTION OF THE DRAWINGS

The present invention can be more fully understood by reading the subsequent detailed description and examples with references made to the accompanying drawings, wherein:

FIG. 1 is a block diagram of the electronic device in accordance to the embodiments of the present disclosure;

FIG. 2 is a flow diagram of a method in accordance to embodiments of the present disclosure;

FIG. 3 is a flow diagram of a method in accordance to embodiments of the present disclosure;

FIG. 4 is a flow diagram of a method in accordance to embodiments of the present disclosure; and

FIG. 5 is a flow diagram of a method in accordance to embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

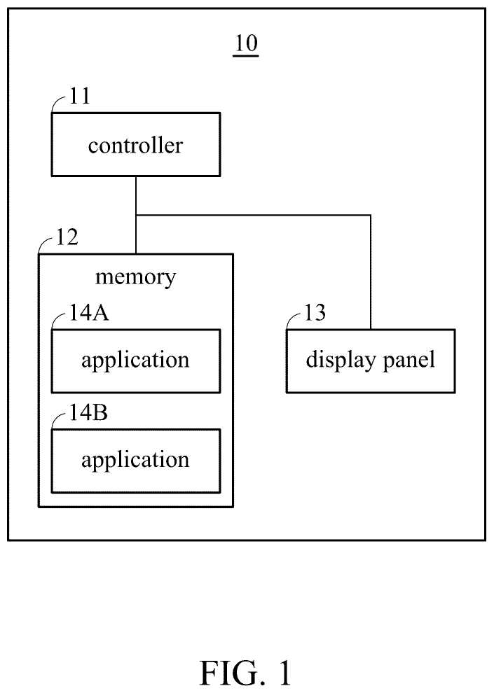

FIG. 1 is a block diagram of the electronic device 10 in accordance to the embodiments of the present disclosure. The electronic device 10 comprises a controller 11, a memory 12, and a display panel 13. The controller 11, the memory 12, and the display panel 13 may connect with each other through a buffer and exchange information with each other. The electronic device 10 may perform various functions to implement processes and methods described herein. For example, the electronic device 10 may be a smartphone, a tablet computer, a notebook computer, a desktop computer, or a smartwatch. The electronic device may be implemented in the form of one or more integrated-circuit (IC) chips.

The controller 11 provides the required process and calculate ability to implement the method of the embodiments. For example, the controller 11 may pervades the process and calculate ability to perform operating systems, programs, software, modules, applications, and functions. In some embodiments, the controller 11 may be implemented in the form of hardware with electronic components, such as transistors, diodes, capacitors, resistors, or inductors. These components are configured and arranged to achieve specific purposes in accordance with the embodiments of the present disclosure. For example, the controller 11 may include a processor, a general purpose micro-processor, a central processing unit (CPU), an application processor, a graphics processing unit (GPU), an image signal processor, a digital signal processor, and/or related chip set. In some embodiments, the controller 11 may be incorporated in the display panel 13.

The memory 12 stores data required by the controller 11. The memory 12 may include non-volatile memories, such as read only memory (ROM), flash memory, hard disk drive, and solid-state disk. The memory 12 may also include volatile memories, such as dynamic random access memory (DRAM) and static random access memory (SRAM). In some embodiments, the memory 12 stores at least one program instruction, such as computer-readable instruction. When the program instruction is read and executed by the controller 11, the program instruction causes the controller 11 to implement methods according to the embodiments of the present disclosure.

In some embodiments, the memory 12 stores application 14A (i.e. a first application) and application 14B (i.e. a second application). The applications 14A and 14B are able to draw (or generate) images at various different frame rates. For a non-limiting example, the applications 14A and 14B may be configured to draw images at 30, 60, 75, 90, or 120 frame per second (FPS). Thus, the applications 14A and 14B may draw 30, 60, 75, 90, or 120 images per second. It is note that these number are just example, and the applications 14A and 14B may have any proper frame rates. In some embodiments, the applications 14A and 14B may be, but not limited to, game applications, live stream applications, or video applications.

The display panel 13 is configured to display images, such as images generated by the applications 14A and 14B. Moreover, the display panel is configured to update displayed images at different refresh rates. For a non-limiting example, the display panel 13 may be configured to update displayed images at 30, 60, 75, 90, or 120 Hz. Thus, the display panel 13 may update the displayed image 30, 60, 75, 90, or 120 times per second. In some embodiments, the display panel 13 is configured to generate a vsync signal at a frequency that is equal to the refresh rate.

As described above, determining an appropriate frame rate of the application is an important issue to the user experience. In general, there are two methods to control the frame rate of the application. The first one is to control the frame rate via counting the vsync signal. However, when the frame rate of the application is not a factor of the refresh rate (such as a 60 FPS frame rate and a 90 Hz refresh rate), this method leads to an in consistent frame display time. The second one is to use a timer specific to the application to control the frame rate. However, it is hard to keep the timer and the refresh rate of the display panel synchronized. Furthermore, when the frame rate is larger than the refresh rate, this method will increase the display latency frame by frame. Embodiments of the present disclosure provide a method for determining the frame rate of the application. Embodiments of the present disclosure also provide a method for controlling the application to draw frames at the determined frame rate.

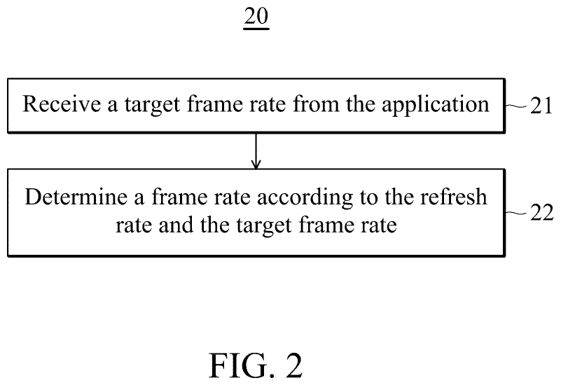

FIG. 2 is a flow diagram of a method 20 in accordance to embodiments of the present disclosure. The method 20 can be implemented in the electronic device 10. In operation 21, the controller 11 receives a target frame rate from the application 14A. The target frame rate is the frame rate that the application 14A expects to achieve, or a desirable frame rate of the application 14A. In operation 22, the controller 11 determines a frame rate according to the refresh rate of the display panel 13 and the target frame rate of the application 14A. The determined frame rate is a factor of the refresh rate. In some embodiments, the controller 11 determines the frame rate according to the refresh rate, the target frame rate, temperature of the electronic device 10, and the charging state of the electronic device 10 (such as the remaining battery power). In some embodiments, the controller 11 determines the frame rate is a number that is lower than the target frame rate and is a factor of the refresh rate, when the temperature of the electronic device 10 is higher than a threshold or the charging state of the electronic device 10 is lower than a threshold.

Because the application 14A is unable to know the refresh rate of the display panel 13 and the temperature and the charging state of the electronic device 10, the target frame rate may not be suitable for the electronic device 10. For example, the target frame rate may not be a factor of the refresh rate. On the other hand, the controller 11 is able to obtain the information about the refresh rate of the display panel 13 and the temperature and the charging state of the electronic device 10. So the controller 11 can determine an appropriate frame rate, which is a factor of the refresh rate, taking the refresh rate (and/or the temperature and the charging state) into consideration. Ensuring the frame rate of the application 14A is a factor of the refresh rate of the display panel 13 can make frame display time consistent, ensure the draw timing of the application matches the update timing of the display panel, and make it easier to control the frame rate.

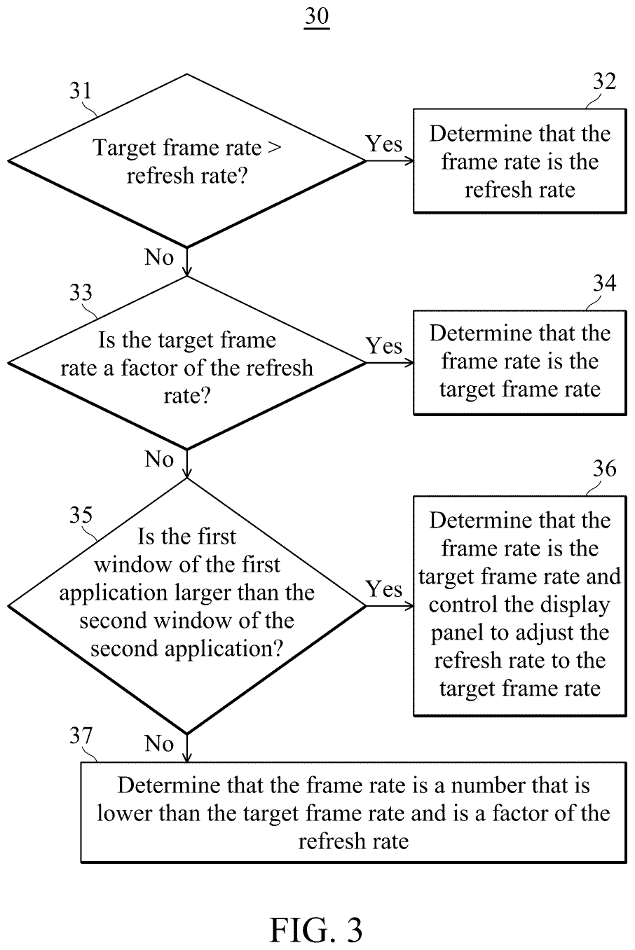

FIG. 3 is a flow diagram of a method 30 in accordance to embodiments of the present disclosure. The method 30 can be implemented in the electronic device 10. Specifically, the method 30 may be a method for determining the frame rate according to the target frame rate and the refresh rate. In operation 31, the controller 11 determines whether the target frame rate is higher than the refresh rate. If the target frame rate is higher than the refresh rate, the controller 11 performs operation 32. If the target frame rate is lower than the refresh rate, the controller 11 performs operation 33. In operation 32, the controller 11 determines that the frame rate is the refresh rate. For example, when the target frame rate is 120 FPS and the refresh rate is 90 Hz, the controller 11 determines that the frame rate is 90 FPS.

In operation 33, the controller 11 determines whether the target frame rate is a factor of the refresh rate. If the target frame rate is a factor of the refresh rate, the controller 11 performs operation 34. If the target frame rate is not a factor of the refresh rate, the controller 11 performs operation 35. In operation 34, the controller 11 determines that the frame rate is the target frame rate. For example, when the target frame rate is 60 FPS and the refresh rate is 120 Hz, the controller 11 determines that the frame rate is 60 FPS. In operation 35, the controller determines whether a first window of the application 14A displayed on the display panel 13 is larger than a second window of the application 14B displayed on the display panel 13. Specifically, the display panel 13 may display a first window corresponding to the application 14A and a second window 14B corresponding to the application 14B at the same time. The image generated by the application 14A is displayed in the first window, and the image generated by the application 14B is displayed in the second window. The first window and the second window may have different sizes, and the sizes of the first window and the second window may be determined by the user. If the first window of the application 14A displayed on the display panel 13 is larger than a second window of the application 14B displayed on the display panel 13, the controller 11 performs operation 36. If the first window of the application 14A displayed on the display panel 13 is smaller than a second window of the application 14B displayed on the display panel 13, the controller 11 performs operation 37.

In operation 36, the controller 11 determines that the frame rate is the target frame rate and controls the display panel to adjust the refresh rate to the target frame rate. For example, when the target frame rate is 90 FPS and the refresh rate is 120 Hz, the controller 11 determines that the frame rate is 90 FPS. The controller 11 also controls the display panel 13 to adjust the refresh rate from 120 FPS to 90 FPS.

In operation 37, the controller 11 determines that the frame rate is a number that is lower than the target frame rate and is a factor of the refresh rate. For example, when the target frame rate is 90 FPS and the refresh rate is 120 Hz, the controller 11 determines that the frame rate is 10, 20, 30, 40, or 60 FPS. In some embodiments, the controller 11 determines that the frame rate is the highest number that is lower than the target frame rate and is a factor of the refresh rate. For example, when the target frame rate is 90 FPS and the refresh rate is 120 Hz, the controller 11 determines that the frame rate is 60 FPS.

The application with larger window size is more important to the user, and the user may pay more attention to the application with larger window. The controller 11 may determine that the application with larger window size has a higher priority. Thus, adjusting the refresh rate to the target frame rate allows the application with higher priority achieve its target frame rate and thus improve the user experience. In some embodiments, after the target frame rate, the refresh rate, the temperature, or the charge state changes, the controller 11 re-determines a new frame rate according to the method described above.

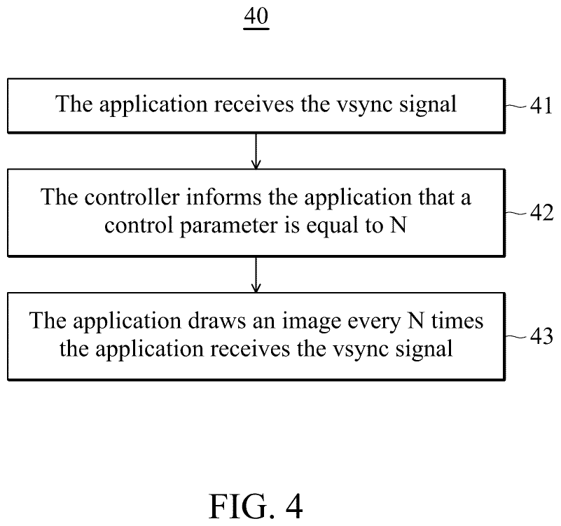

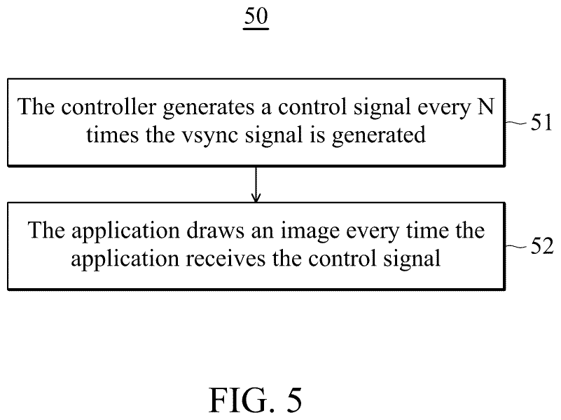

Embodiments of the present disclosure also provide methods for controlling the application to draw or generate frames at the determined frame rate. Refer to FIGS. 4 and 5, FIGS. 4 and 5 are flow diagrams of the method 40 and the method 50 in accordance to embodiments of the present disclosure. The method 40 and the method 50 can be implemented in the electronic device 10. After the frame rate has been determined in operation 22 (e.g. based on the method 30), the controller 11 may control the application 14A to draw images at the determined frame rate using either the method 40 or the method 50.

Refer to FIG. 4, in operation 41, the application 14A receives the vsync signal. As described above, the display panel 13 is configured to generate a vsync signal at a frequency that is equal to the refresh rate. For example, the vsync signal may be in the form of a pulse signal. The application 14A may receive this vsync signal from the display panel 13. In operation 42, the controller 11 informs the application 14A that a control parameter is equal to N. N is the refresh rate divided by the frame rate. The controller 11 is configured to calculate the control parameter according to the determined frame rate and the refresh rate and inform the application 14A the calculated control parameter. For example, when the determined frame rate is 90 FPS and the refresh rate is 90 Hz, the control parameter is 1. When the determined frame rate is 60 FPS and the refresh rate is 120 Hz, the control parameter is 2. When the determined frame rate is 30 FPS and the refresh rate is 120 Hz, the control parameter is 4.

In operation 43, the application 14A draws an image every N times the application 14A receives the vsync signal. For example, when the control parameter is 2, the application 14A draws an image at the second, fourth, sixth . . . time the application 14A receives the vsync signal. When the control parameter is 4, the application 14A draws an image at the fourth, eighth, twelfth . . . time the application 14A receives the vsync signal.

Refer to FIG. 5, in operation 51, the controller 11 generates a control signal every N times the vsync signal is generated. N is the refresh rate divided by the frame rate. The application 14A may receive this vsync signal from the display panel 13 and generate the control signal every N times the controller 11 receives the vsync signal. The controller 11 may calculate N in the same way described in operation 42. For example, when the control parameter is 2, the controller 11 generates the control signal at the second, fourth, sixth time the controller 11 receives the vsync signal. When the control parameter is 4, the controller 11 generates the control signal at the fourth, eighth, twelfth . . . time the controller 11 receives the vsync signal. In some embodiments, the control signal may be in the form of a pulse signal. In operation 52, the application 14A draws an image every time the application 14A receives the control signal.

Method 40 and method 50 enable the application 14A to achieve the determined frame rate, which is 1/N of the refresh rate. Furthermore, method 40 and method 50 allow the timing that the application 14A draws the image matches the timing that the display panel updates the displayed image.

Embodiments of the disclosure provide methods for determining appropriate frame rate of the application and methods for controlling the application to draw images at the determined frame rate. Embodiments of the disclosure can ensure the frame rate is a factor of the refresh rate and thus ensure the draw timing of the application matches the update timing of the display panel. Furthermore, embodiments of the disclosure can precisely control the frame rate of the application to make sure the application achieve the determined frame rate.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a display panel, configured to update displayed images at a refresh rate; and
a controller, coupled to the display panel;
wherein the controller is configured to:
receive a target frame rate from a first application;
determine a frame rate according to the refresh rate and the target frame rate, wherein the frame rate is a factor of the refresh rate; and
control the first application to draw images at the frame rate.

2. The electronic device as claimed in claim 1, wherein the display panel generates a vsync signal at a frequency that is equal to the refresh rate, and the first application receives the vsync signal;
wherein the controller is further configured to inform the first application that a control parameter is equal to N;
wherein the first application is configured to draw an image every N times the first application receives the vsync signal;
wherein N is the refresh rate divided by the frame rate.

3. The electronic device as claimed in claim 1, wherein the display panel generates a vsync signal at a frequency that is equal to the refresh rate, and the controller is further configured to generate a control signal every N times the vsync signal is generated, wherein N is the refresh rate divided by the frame rate;
wherein the first application is configured to draw an image every time the first application receives the control signal.

4. The electronic device as claimed in claim 1, wherein when the target frame rate is higher than the refresh rate, the controller is further configured to determine that the frame rate is the refresh rate.

5. The electronic device as claimed in claim 1, wherein, when the target frame rate is lower than the refresh rate and the target frame rate is not a factor of the refresh rate, and
when a first window of the first application displayed on the display panel is smaller than a second window of a second application displayed on the display panel,
the controller is further configured to determine that the frame rate is a number that is lower than the target frame rate and is a factor of the refresh rate.

6. The electronic device as claimed in claim 5, wherein the controller is configured to determine that the frame rate is the highest number that is lower than the target frame rate and is a factor of the refresh rate.

7. The electronic device as claimed in claim 1, wherein, when the target frame rate is lower than the refresh rate and the target frame rate is not a factor of the refresh rate, and
when a first window of the first application displayed on the display panel is larger than a second window of a second application displayed on the display panel,
the controller is further configured to determine that the frame rate is the target frame rate and to control the display panel to adjust the refresh rate to the target frame rate.

8. The electronic device as claimed in claim 1, wherein, when the target frame rate is lower than the refresh rate and the target frame rate is a factor of the refresh rate, the controller is further configured to:
determine that the frame rate is the target frame rate.

9. The electronic device as claimed in claim 1, wherein when remaining battery power of the electronic device is lower than a first threshold or temperature of the electronic device is higher than a second threshold, the controller is further configured to control the first application to lower its frame rate.

10. A method for controlling frame rate of an application, wherein the method is applicable to an electronic device, wherein the electronic device comprises a display panel and a controller coupled to the display panel, wherein the display panel is configured to update displayed images at a refresh rate;
wherein the method comprises:
receiving, via the controller, a target frame rate from a first application;
determining, via the controller, a frame rate according to the refresh rate and the target frame rate, wherein the frame rate is a factor of the refresh rate; and
controlling, via the controller, the first application to draw images at the frame rate.

11. The method as claimed in claim 10, further comprising:
generating, via the display panel, a vsync signal at a frequency that is equal to the refresh rate;
receiving, via the first application, the vsync signal;
informing, via the controller, the first application that a control parameter is equal to N; and
drawing, via the first application, an image every N times the first application receives the vsync signal;
wherein N is the refresh rate divided by the frame rate.

12. The method as claimed in claim 10, further comprising:
generating, via the display panel, a vsync signal at a frequency that is equal to the refresh rate;
generating, via the controller, a control signal every N times the vsync signal is generated, wherein N is the refresh rate divided by the frame rate; and
drawing, via the first application, an image every time the first application receives the control signal.

13. The method as claimed in claim 10, further comprising:
determining, via the controller, that the frame rate is the refresh rate, when the target frame rate is higher than the refresh rate.

14. The method as claimed in claim 10, wherein when the target frame rate is lower than the refresh rate and the target frame rate is not a factor of the refresh rate, and
when a first window of the first application displayed on the display panel is smaller than a second window of a second application displayed on the display panel,
the method further comprises:
determining, via the controller, that the frame rate is a number that is lower than the target frame rate and is a factor of the refresh rate.

15. The method as claimed in claim 14, further comprising:
determining, via the controller, that the frame rate is the highest number that is lower than the target frame rate and is a factor of the refresh rate.

16. The method as claimed in claim 10, wherein, when the target frame rate is lower than the refresh rate and the target frame rate is not a factor of the refresh rate, and
when a first window of the first application displayed on the display panel is larger than a second window of a second application displayed on the display panel,
the method further comprises:
determining, via the controller, that the frame rate is the target frame rate and to control the display panel to adjust the refresh rate to the target frame rate.

17. The method as claimed in claim 10, wherein, when the target frame rate is lower than the refresh rate and the target frame rate is a factor of the refresh rate, the method further comprises:
determining, via the controller, that the frame rate is the target frame rate.

18. The method as claimed in claim 10, further comprising:
controlling, via the controller, the first application to lower its frame rate, when the remaining battery power of the electronic device is lower than a first threshold or the temperature of the electronic device is higher than a second threshold.
